(19) United States
(12) Patent Application Publication
(10) Pub. No.: US 2026/0066176 A1
(43) Pub. Date: Mar. 5, 2026

(54) COOLING DEVICE FOR AN INDUCTOR WINDING

(71) Applicant: Rolls-Royce Deutschland Ltd & Co KG, Blankenfelde-Mahlow (DE)

(72) Inventors: Shuai WANG, Singapore (SG); Chandana J. GAJANAYAKE, Singapore (SG); Suping SHEN, Singapore (SG); Pranshu KHARBANDA, Singapore (SG)

(21) Appl. No.: 19/315,463

(22) Filed: Aug. 29, 2025

(30) Foreign Application Priority Data
Sep. 3, 2024 (GB) 2412889.4

(51) Int. Cl. H01F 27/08; H01F 27/32

(52) U.S. Cl. CPC H01F 27/08; H01F 27/324

(57) ABSTRACT

A cooling device for an inductor winding includes an inductor assembly that has a magnetic core and a multi-turn winding wound around the magnetic core. The magnetic core has a window area. Inner winding sections of the multi-turn winding are arranged in the window area. The cooling device also includes a heat sink and a heat conducting element. The heat conducting element has a first section that is thermally coupled to the heat sink, and a second section that extends angularly with respect to the first section. The second section extends into the window area of the magnetic core.

### PRIORITY

This application claims the benefit of United Kingdom patent application GB 2412889.4, filed on Sep. 3, 2024, which is hereby incorporated by reference in its entirety.

### BACKGROUND

### Technical Field

The present disclosure relates to a cooling device for an inductor winding and a printed circuit board assembly implementing such cooling device.

### Description of the Related Art

With increased penetration of electrical systems and the progression towards full electric and hybrid propulsion systems, the use of energy storage systems and DC power distribution has gained increased use. Multiple loads and sources may be connected to a DC distribution network. In such DC network, adequate filtering functions such as for filtering noise produced by power electronic converters may be implemented using inductors or chokes, where a conductive wire or rigid strips is/are wound helically around a magnetically permeable core.

It may be preferred for the inductors and chokes to have high inductance values for the filtering functions, which may be realized by either more winding turns or more magnetic cores. However, magnetic cores may be heavy and bulky in volume and may drastically increase the weight and size of the built inductors or chokes. Increasing the number of winding turns may achieve high inductance with the same magnetic core or the same inductance with a smaller core. Therefore, as many as possible turns are to be accommodated in the core to achieve power dense inductors or chokes. However, with cores, the inner space referred to as the window area may be limited. The more winding turns are to be fitted in a fixed core, the less conduction area each winding turn will have, which leads to higher copper temperatures. Accordingly, cooling of the winding segments in the window area is to be provided to realize power-dense inductors and chokes.

### SUMMARY AND DESCRIPTION

The scope of the present invention is defined solely by the appended claims and is not affected to any degree by the statements within this summary.

The present embodiments may obviate one or more of the drawbacks or limitations in the related art. For example, a cooling device that allows efficient cooling of the winding segments located in the window area of an inductor core is provided.

In a first aspect, a cooling device for an inductor winding is provided. The cooling device includes an inductor assembly that includes a magnetic core and a multi-turn winding wound around the core. The core has a window area, and inner winding sections of the multi-turn winding are arranged in the window area. The cooling device further includes a heat sink and a heat conducting element. The heat conducting element includes a first section that is thermally coupled to the heat sink and further includes a second section that extends angularly (e.g., perpendicularly with respect to the first section). The second section extends into the window area of the core.

The cooling device is configured to provide for the cooling of the window area of a core and of the winding segments arranged in such window area by providing a heat conducting element. One section of the heat conducting element is arranged in and thermally coupled to the window area to absorb heat, and another section of the heat conducting element is thermally coupled to and cooled by a heat sink, thereby providing for an additional thermal conduction path from the window area to the heat sink.

The cooling device may be a thermal management device that may provide inductor assemblies such as multi-turn inductors or chokes with high current density. The thermal management device allows the current density to be increased by creating a dedicated and efficient thermal conduction path from the electrically conductive windings to the system heat sink. The region with the highest volumetric heat generation (e.g., the center, such as the window area) may be efficiently cooled by effectively transporting heat to the intended heat-sinking structures. The additional thermal conduction path may be realized with heat conducting elements in the form of light-weighted “pipe” structures with high thermal conductivity along the longitude direction, such as heat pipes, while satisfying electrical insulation requirements.

Structures of the cooling device of the present disclosure may be easily integrated with mechanical mounting structures of inductor assemblies. Therefore, with only minor increases in the structural complexity, weight, and volume, the cooling device of the present disclosure is able to increase the current density of inductor assemblies such as inductors and chokes, which increases the power density of the inductor assemblies.

A further advantage associated with the cooling device of the present disclosure lies in that the peak temperature of the inductor may be notably reduced, leading to increased insulation reliability and longer lifetime. Further, the present solution is highly customizable based on space constraints, operation parameters, and thermal performance criteria.

It is pointed out that the language that the first section of the conducting element is thermally coupled to the heat sink is to be understood to include that first section may be arranged on or in the heat sink and may be embedded in the heat sink material.

The magnetic core of the inductor assembly may be a toroid core with circular, oval or rectangular shape. The heat conducting element may be a longitudinal (e.g., elongated) heat conducting element.

In some embodiments, the first section of the heat conducting element extends in a plane of the heat sink, thereby allowing effective heat transfer along the first section into the heat sink. For example, a straight first section may be embedded in the heat sink material over its length.

In some embodiments, the first section of the heat conducting element includes a spiral extension that is arranged in the heat sink. A spirally wound form of the second section of the heat conducting element allows to increase the length of the second section along which heat may be conducted into the heat sink.

In some embodiments, the cooling device includes a plurality of heat conducting elements each of which is L-shaped (e.g., providing that the heat conducting element includes two sections that are bent relative to each other to form an angle). Each of the heat conducting elements includes a first section thermally coupled to the heat sink and a second section extending into the window area of the core. The first sections are distanced in the circumferential direction. The second sections may run in parallel next to each other. Such embodiments allow an increase in heat transfer into the heat sink by providing a plurality of heat conducting elements. The first sections that are distanced in the circumferential direction may be evenly spaced.

In some embodiments, the first sections and the second sections may each be straight sections. However, other forms of the first and/or second sections may be implemented. For example, the first sections thermally coupled to the heat sink may alternatively have a wavy or snake structure.

In some embodiments, the cooling structure is implemented in a printed circuit board arrangement, where the inductor assembly is arranged on the upper side of a printed circuit board and the heat sink is arranged on the lower side of the printed circuit board. To provide for a heat conduction path in such a case, the second section of the heat conducting element extends through the printed circuit board, connecting the first section arranged in the heat sink with the window area. In particular, the second section extends vertically from the first section (e.g., which may be arranged as a straight section or be wound spirally within a plane of the heat sink as discussed).

It is pointed out that within the present disclosure that side of the printed circuit board at which the inductor assembly is arranged is considered to be the upper side irrespective of the actual orientation of the printed circuit board in space.

In some embodiments, the cooling device further includes a thermal interface material arranged between the lower side of the printed circuit board and the heat sink. The second section of the heat conducting element also extends through the thermal interface material. The thermal interface material serves to eliminate height differences and improve heat transfer from the printed circuit board and, in some embodiments, from electric modules arranged on the lower side of the printed circuit board to the heat sink. The thermal interface material may be formed by a thermal pad or by a thermal paste in embodiments.

In some embodiments, the multi-turn winding wound around the core includes a plurality of preformed conductor bars, where each conductor bar includes an inner bar section arranged in the window area of the core and an outer bar section arranged at the outside of the core. In such embodiments, the traditional wire bent around a core is replaced by preformed bars that do not need to be bent, this allowing for a simplified manufacturing process and high precision.

In some embodiments, the conductor bars are U-shaped and connected at their ends to conductor plates that are integrated in the printed circuit board, which allows to electrically connect the conductor bars in a simple manner. The U-shaped bars together with the conductor plates form one winding or several windings (e.g., two windings in case of common mode choke) around the core.

In some embodiments, however, the multi-turn winding may be formed in a traditional manner by one or several wires of, for example, circular or rectangular cross-section that are wound and bent around the core.

In some embodiments, the cooling device further includes an insulation core that is arranged in the window area of the core, where the second section of the heat conducting element extends through the insulation core. The insulation core is an element that is arranged inside the window area. The insulation core is made of an electrically insulating material such as a plastic or resin material and provides insulation between the inner winding segments that are arranged in the window area. At the same time, such insulation core provides a structure for guiding and holding the second section of the heat conducting element. Heat from the inner winding segments may be transferred through the insulation core to the second section of the heat conducting element.

In some embodiments, the insulation core is split in a plurality of sectors that are arranged circumferentially and together, in cross-section, form a circle. At least one of the sectors includes the second section of a heat conducting element. In such embodiments, it may be further provided that the insulation core sectors each include one of the conductor bars mentioned before. Accordingly, the insulation core may form sectors that provide structure for the second section of the heat conducting element, and may additionally form conductor bars of the inductor winding.

The core may have a plurality of cross-sections. In some embodiments, the core has a circular or rectangular cross-section. A rectangular cross-section is particularly suitable if the winding is formed by preformed conductor bars.

The second section of the heat conducting element extends into the window area of the core. In some embodiments, the second section of the heat conducting element may extend into the center of the window area. In some embodiments, there may be provided several heat conducting elements with several second sections that may be arranged at different locations in the window area or may all be located in the center of the window area.

In some embodiments, the second section of the heat conducting element runs straight. This way, the second section absorbs little space in the window area of the toroid.

The heat conducting element may be of any structure that allows to conduct heat efficiently from the second section to the first section. In principle, the heat conducting element may be a solid rod of material with a high thermal conductivity such as copper or a copper alloy, or aluminum or an aluminum alloy. In some embodiments, the heat conducting element is a copper element (e.g., a copper rod). In some embodiments, the heat conducting element is a heat pipe that employs a phase transition to transfer heat between a hot interface and a cold interface, as is well known to the person skilled in the art. Heat pipes are inexpensive and require little maintenance efforts.

Generally, if the heat conducting element is of a material that is electrically conductive, the heat conducting element may be coated with an insulating material.

In some embodiments, the inductor assembly may be an inductor or a choke. An inductor may include one multi-turn winding. A common mode choke is an electrical filter that blocks high-frequency noise common to two or more power lines while allowing a desired DC or low-frequency signal to pass. A common mode choke may include two multi-turn windings which are mirror symmetrical to one another.

In a second aspect, there is provided a printed circuit board assembly. The printed circuit board assembly includes a printed circuit board having an upper side and a lower side, and an inductor assembly arranged on the upper side of the printed circuit board. The inductor assembly includes a magnetic core and a multi-turn winding wound around the core. The core has a window area. Inner winding sections of the multi-turn winding are arranged in the window area. The printed circuit board assembly also includes a heat sink arranged on the lower side of the printed circuit board, and a heat conducting element. The heat conducting element includes a first section that is arranged in the heat sink and further includes a second section that extends vertically from the first section through the printed circuit board into the window area of the core.

Embodiments of the printed circuit board assembly correspond to those discussed with the cooling device. For example, in some embodiments, the first section of heat conducting element may include a spiral extension that is arranged in the heat sink.

In some embodiments, a plurality of heat conducting elements each of which is L-shaped is provided for. Each of the heat conducting elements includes a first section thermally coupled to the heat sink and a second section extending into the window area of the core. The first sections are distanced in the circumferential direction.

The skilled person will appreciate that except where mutually exclusive, a feature or parameter described in relation to any one of the above aspects may be applied to any other aspect. Further, except where mutually exclusive, any feature or parameter described herein may be applied to any aspect and/or combined with any other feature or parameter described herein.

### BRIEF DESCRIPTION OF THE DRAWINGS

The cooling device of the present disclosure will be explained in more detail on the basis of example embodiments with reference to the accompanying drawings in which:

FIG. 1 is an exploded view of an embodiment of a cooling device for an inductor winding;

FIG. 2 is a side view of the cooling device of FIG. 1 in the assembled state;

FIG. 3 is a perspective view of a heat sink and a heat conducting element of the cooling device of FIG. 1;

FIG. 4 is a top view on the cooling device of FIG. 1 in the assembled state, where no insulation core is arranged in the window area of the core;

FIG. 5 is another top view on the cooling device of FIG. 1 in the assembled state, where an insulation core is arranged in the window area of the core;

FIG. 6 is a further embodiment of a cooling device that implements a plurality of heat conducting elements each of which is L-shaped;

FIG. 7 is a top view on a cooling device similar to the cooling device of FIG. 1, where a plurality of L-shaped heat conducting elements are implemented;

FIG. 8 is a top view on a cooling device similar to the cooling device of FIG. 1, where both L-shaped heat conducting elements and other heat conducting elements are implemented;

FIG. 9 shows a sector of an insulation core that integrates both a section of a heat conducting element and a conductor bar;

FIG. 10 shows an inductor having a single winding wound around a core; and

FIG. 11 shows a common mode choke having two windings wound around a core, with the two winding opposing each other magnetically.

### DETAILED DESCRIPTION

In the following, a cooling device for inductor windings is described. Such cooling device may be implemented in a plurality of electrical circuits. Embodiments of such electrical circuits include DC power distribution networks as implemented in full electric and hybrid propulsion systems. For example, the cooling device of the present disclosure may be implemented as an inductor or as a common mode choke in a power converter circuitry that includes a plurality of semiconductor switches, the switching of which brings about the challenge of differential and common mode noises.

The noises may lead to electromagnetic interference problems and frequently require filtering before the power converters are allowed to be connected to a DC distribution network. Such filtering function in most cases involves inductors or chokes, which mainly consists of conductive wires or rigid strips helically wound around magnetically permeable cores. By manipulating the magnetic axis of the helical windings, inductors are intended to induce a major amount of magnetic flux in the cores, while chokes are intended not to induce any magnetic flux in the cores with the intended electrical current.

The inductors and chokes may have high inductance values for the filtering functions, which may be realized by either more winding turns or more magnetic cores. As magnetic cores may be heavy and bulky in volume, the number of winding turns may be increased. This need, however, is confronted with the fact that the inner space inside a core, such as a toroid core (e.g., the window area) is limited. The more winding turns are to be fitted in a fixed core, the less conduction area each winding turn will have, which leads to higher copper temperatures. Cooling of the winding segments in the window area is thus critical to realize power-density inductors and chokes.

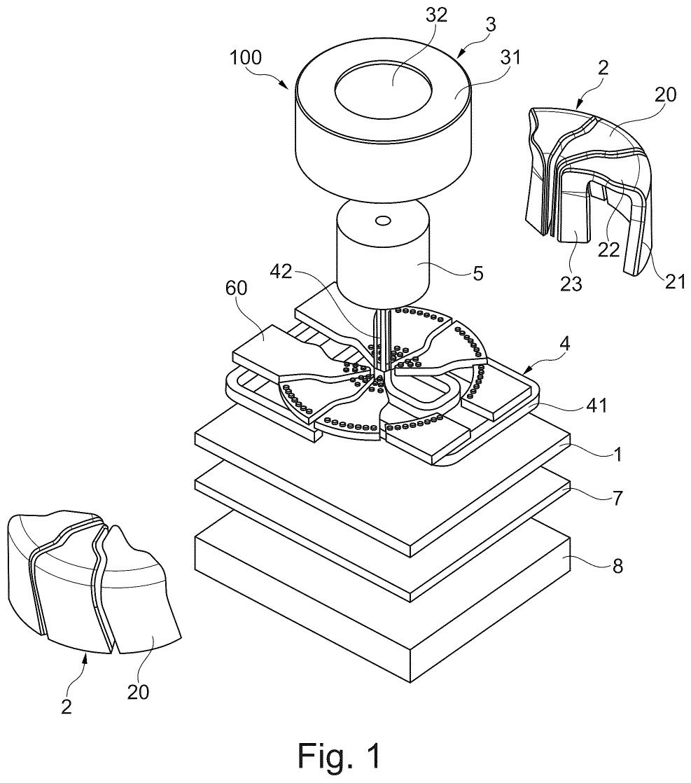

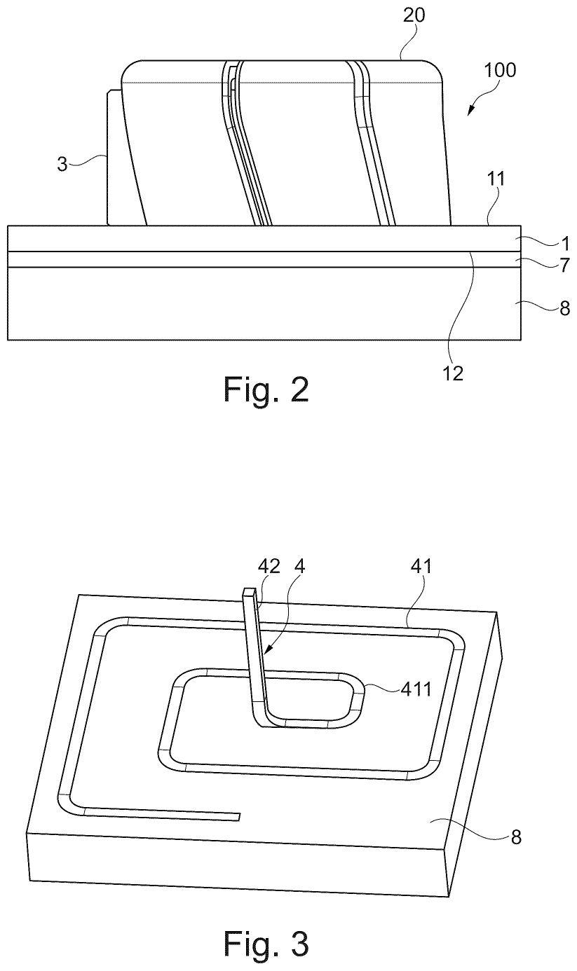

FIG. 1 is an exploded view of an embodiment of a cooling device of the present disclosure. FIG. 2 is a side view of the assembled cooling device of FIG. 1, and FIG. 3 shows elements of the cooling device of FIG. 1. In the following, reference is initially made to all of FIGS. 1 to 3.

The cooling device includes a printed circuit board 1 that includes an upper side 11 and a lower side 12. On the upper side 11 of the printed circuit board 1, an inductor assembly 100 is arranged. The inductor assembly 100 includes a magnetic toroid core 3 and a multi-turn winding 2.

The magnetic toroid core 3 includes a toroid ring 31 that, at its inside, forms a hole 32 that is referred to as window area. The toroid ring 31 may have a rectangular or circular cross-section. The core 3 may be made of any magnetic material, such as a ferromagnetic or ferromagnetic material. The magnetic material may be a in iron-based alloy.

The multi-turn winding 2 in the depicted embodiment, but not necessarily, is formed in a particular manner in that the winding 2 is formed by separate conductor bars 20 that are each U-shaped. Each U-shaped conductor bar 20 includes an outer segment or section 21 that extends at the outside of toroid ring 31, an inner segment or section 23 that extends at the inside of toroid ring 31 and, accordingly, in the window area 32, and a top segment or section 22 that connects sections 21, 23 and extends over the top end face of the toroid ring 31. The multi-turn winding 2 further includes copper layers 60 that form conductor plates and are arranged in the printed circuit board 1, to which the U-shaped conductor bars 20 are electrically connected, such that together a continuous inductor winding 2 is formed. The advantage of an inductor winding implemented in such manner lies in that preformed conductor bars that do not require bending and may be formed in a simple manner with high precision may be implemented. Further, the winding may be electrically contacted and controlled through the printed circuit board 1.

In other embodiments, however, a traditional wire may be wound and bent around the toroid ring 31.

Irrespective of the particular implementation of the winding 2, it is obvious that space is limited in the window area 32. Accordingly, the inner segments 23 of the winding 2 that are arranged in the window area 32 are at close distance and cannot dissipate heat efficiently. Further, because of the limited space, the cross section of the inner segments (e.g., segments 23 in FIG. 1) may be reduced, this leading to the production of additional heat.

The cooling device of FIGS. 1 to 3 provides for an additional thermal conduction path that allows to efficiently transfer heat from the window area 32 and the winding segments 23 arranged in the window area 32 to a heat sink. The additional thermal conduction path is provided for by a longitudinal heat conducting element 4, which may be implemented as a heat pipe that employs a phase transition to transfer heat between a hot interface and a cold interface. The heat conducting element 4, as shown in FIG. 3, includes a first section 41 that is arranged in a heat sink 8 and further includes a second section 42 that extends perpendicularly and vertically up from the first section 41.

More particularly, as shown in FIG. 3, the first section 41 extends in a plane of the heat sink 8, where the first section 41 forms a spiral extension 411 that is spirally wound. The spirally wound first section 41 is embedded in the material of the heat sink 8, where the material of the heat sink 8 covers the first section 41 at at least three sides. By spirally winding the first section 41, a length of the first section 41 and thus the heat transfer into the heat sink 8 may be increased. It is pointed out that the first section 41, even though spirally wound, is formed by a longitudinal heat conducting element. The attribute “longitudinal” refers to the form of the heat conducting element and not to the manner in which the heat conducting element is arranged in the heat sink 8. The heat conducting element 4 may be uniformly shaped. Further, the heat conducting element 4 may be electrically insulated according to system installation coordination rules. Similarly, the conductor bars 20 may be electrically insulated.

The second section 42 runs straight and extends vertically from the first section 41 into the window area 32 of the toroid core 3, such that the second section 42 may absorb heat produced by the inner winding sections 23. For example, as the heat conducting element 4 (e.g., a heat pipe) has a very high thermal conductivity along the longitudinal direction, heat from the second section 42 in the window area 32 is effectively transferred into the spirally wound first section 41.

In the embodiment of FIG. 3, the heat conducting member 4 has a rectangular cross-section. However, in other embodiments, the cross section may be circular, polygonal, or elliptical.

Referring to FIGS. 1 and 2, the heat sink is arranged at the lower side 12 of the digital circuit board 1. Accordingly, the vertically extending second section 42 of the heat conducting element 4 extends through the printed circuit board 1. This fact is not, however, shown in the schematic explosive view of FIG. 1 but is clear when considering FIGS. 1 and 3 together. A thermal interface material 7 may be arranged between the lower side 12 of the printed circuit board and the heat sink 8. Naturally, the second section 42 of the heat conducting element 4 also extends through the thermal interface material 7.

FIG. 1 further depicts an insulation core 5 that is arranged inside the window area 32 of the toroid core 3. The insulation core 5 is comprised of an insulating material. The insulation core 5 serves to hold the second section 42 of the heat conducting element 4 centrally inside the window area 32 and may also serve to isolate the inner winding sections 23 of the winding 2 from each other. Also, the insulation core 5 may form an encapsulation to maintain proper thermal conductance while introducing reliable electric insulation.

The embodiment of FIGS. 1 to 3 is integrated into a printed circuit board arrangement, where, however, this is not necessarily the case and contacting of the winding 2 may be implemented in other ways than a printed circuit board.

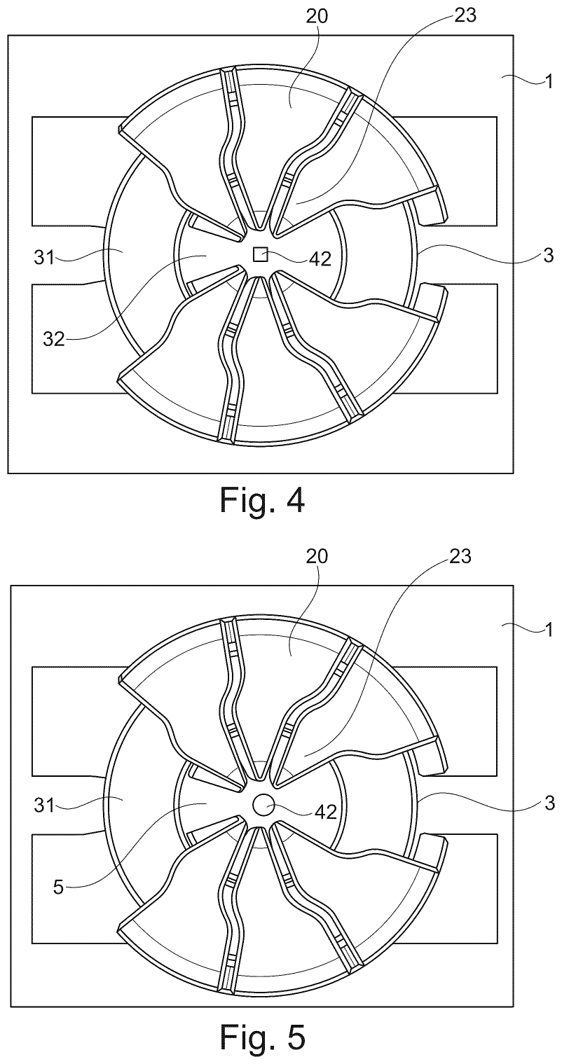

FIG. 4 is a top view on the assembled cooling device of FIGS. 1 to 3 except that in FIG. 4 the insulation core 5 is not present to indicate that the insulation core 5 is optional. In such case, the window area 32 is not filled with material except the inner winding sections 23 and the second section 42 of the heat conducting element 4.

FIG. 5 is a top view of the assembled cooling device is of FIGS. 1 to 3, where in FIG. 5, the insulation core 5 depicted in FIG. 1 is also present.

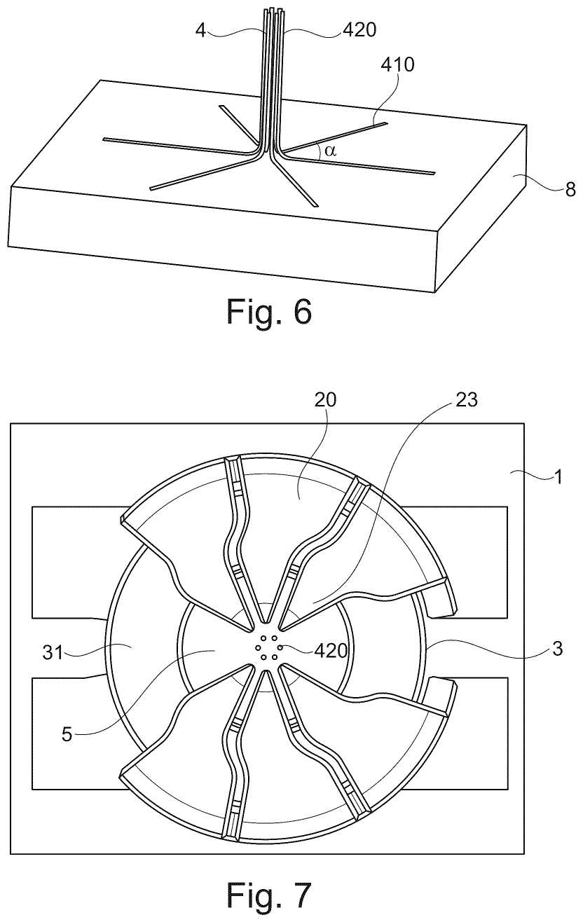

FIG. 6 depicts a further embodiment of a cooling device for an inductor winding that, in principle, may be implemented in the same manner as in FIG. 1, but in which the heat conducting element is formed in a different manner in that, first, not a single heat conducting element is implemented but a plurality of heat conducting elements, and in that, second, the heat conducting elements are each L-shaped.

More particularly, each heat conducting element 4 includes a first straight section 410 that is arranged in the heat sink 8 and a second straight section 420 that extends vertically (e.g., through the thermal interface material and the printed circuit board of FIG. 1) into the window area 32 of the toroid core 3. The plurality of L-shaped heat conducting elements 4 is arranged such that the first straight sections 410 that are arranged in the heat sink 8 are distanced in the circumferential direction by an angle α, where the same angle α may be present between each of the straight sections 410 (e.g., where the angle α is 60 degrees in the depicted embodiment in which six straight sections 410 are arranged at equal distance circumferentially in the horizontal plane of the heat sink 8). The second straight sections 420, on the other hand, run in parallel next to each other to extend into the window area 32 of the toroid core 3.

FIG. 7 is a top view on an assembled cooling device similar to that of FIG. 1, where, however, a plurality of L-shaped heat conducting elements 4 are implemented in accordance with FIG. 6. The respective ends of the straight sections 420 are shown in FIG. 7. In FIG. 7, similar to FIG. 5, the straight sections 420 extend in an insulation core 5 that is arranged in the window area 32.

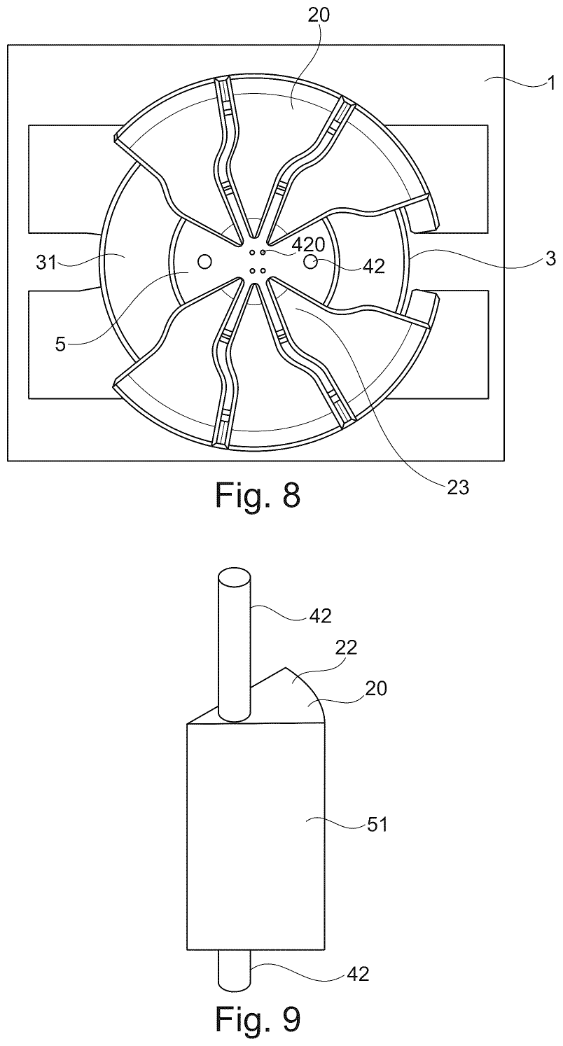

FIG. 8 is another top view on an assembled cooling device similar to that of FIG. 1, where an embodiment is shown in which both L-shaped heat conducting elements with second sections 420 similar to those shown in FIG. 6 and other heat conducting element sections 42 that may be similar to those shown in FIG. 3 are implemented. FIG. 8 illustrates that any number of second sections 42, 420 of heat conducting elements 4 may be arranged in the window area 32, in multiple arrangements.

FIG. 9 depicts an embodiment in which the insulation core 5 depicted in FIGS. 1, 5, 7 and 8 is not formed uniformly, but by a plurality of sectors 51 that are arranged circumferentially. Sector 51 on the one hand structurally binds the vertical second section 42 of a heat conducting element and represents a mechanical binding structure. Further, the section 51 may integrate a conductor bar 20 of the kind discussed with respect to FIG. 1, where the top section 22 is depicted only. The insulation core sector 51 may be realized with an encapsulation or similar method, while providing proper thermal conductance and electric insulation.

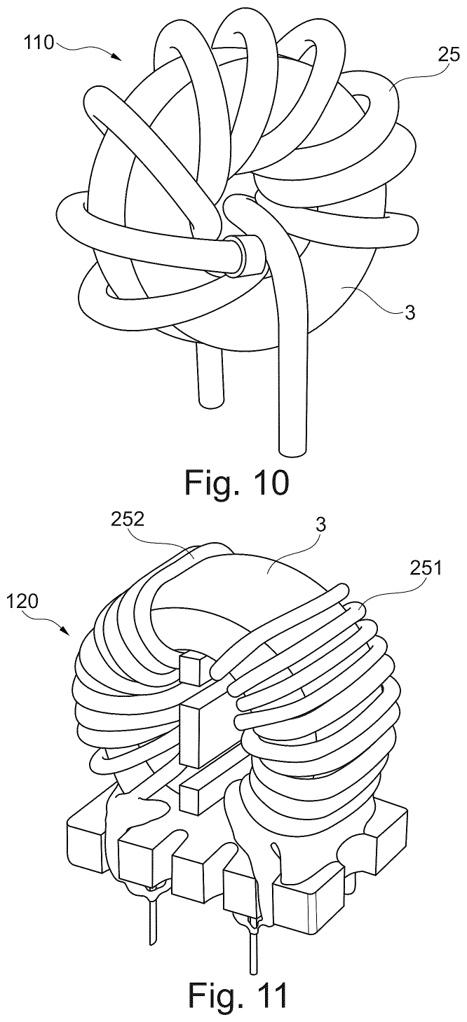

FIG. 10 shows an inductor that implements a single copper wire 25 helically around a magnetic toroid core 3. FIG. 10 serves to illustrate that the cooling device of the present disclosure may be implemented to include an inductor as inductor assembly, and also may be implemented using wires instead of preformed conductor bars 20.

FIG. 11 shows a common mode choke 120 that implements to copper wires 251, 252 wound around a magnetic toroid core 3, with the two coils formed by the copper wires 251, 252 creating opposing magnetic fields. FIG. 12 serves to illustrate that the cooling device of the present disclosure may be implemented to include a choke as inductor assembly, and also may be implemented using wires instead of preformed conductor bars 20.

It should be understood that the above description is intended for illustrative purposes only, and is not intended to limit the scope of the present disclosure in any way. For example, two heat sinks may be implemented in other embodiments, wherein the structure to be cooled is sandwiched between the two heat sinks which provide for a double-sided cooling, wherein the straight sections of two heat conducting elements extend into the window area from opposite sides.

Also, those skilled in the art will appreciate that other aspects of the disclosure can be obtained from a study of the drawings, the disclosure and the appended claims. All methods described herein can be performed in any suitable order unless otherwise indicated herein or otherwise clearly contradicted by context. Various features of the various embodiments disclosed herein can be combined in different combinations to create new embodiments within the scope of the present disclosure. In particular, the disclosure extends to and includes all combinations and sub-combinations of one or more features described herein. Any ranges given herein include any and all specific values within the range and any and all sub-ranges within the given range.

1. A cooling device for an inductor winding, the cooling device comprising:
an inductor assembly comprising a magnetic core and a multi-turn winding wound around the magnetic core, the magnetic core having a window area, wherein inner winding sections of the multi-turn winding are arranged in the window area;
a heat sink; and
at least one heat conducting element comprising:
a first section that is thermally coupled to the heat sink; and
a second section that extends angularly with respect to the first section,
wherein the second section of the at least one heat conducting element extends into the window area of the magnetic core.

2. The cooling device of claim 1, wherein the first section of the at least one heat conducting element extends in a plane of the heat sink.

3. The cooling device of claim 1, wherein the first section of the at least one heat conducting element comprises a spiral extension that is arranged in the heat sink.

4. The cooling device of claim 1, wherein the at least one heat conducting element comprises a plurality of heat conducting elements, each heat conducting element of the plurality of heat conducting elements being L-shaped,
wherein each heat conducting element of the plurality of heat conducting elements comprises a first section thermally coupled to the heat sink and a second section extending into the window area of the magnetic core, and
wherein the first sections are distanced in a circumferential direction.

5. The cooling device of claim 4, wherein the first sections and the second sections are each straight sections.

6. The cooling device of claim 1, wherein the inductor assembly is arranged on an upper side of a printed circuit board,
wherein the heat sink is arranged on a lower side of the printed circuit board, and the second section of the at least one heat conducting element extends through the printed circuit board.

7. The cooling device of claim 6, further comprising a thermal interface material arranged between the lower side of the printed circuit board and the heat sink,
wherein the second section of the at least one heat conducting element also extends through the thermal interface material.

8. The cooling device of claim 1, wherein the multi-turn winding wound around the magnetic core comprises a plurality of preformed conductor bars, each conductor bar of the plurality of preformed conductor bars comprising an inner bar section arranged in the window area of the magnetic core and an outer bar section arranged at the outside of the magnetic core.

9. The cooling device of claim 8, wherein the plurality of preformed conductor bars are U-shaped and connected at ends of the plurality of preformed conductor bars to conductor plates that are integrated in the printed circuit board.

10. The cooling device of claim 1, further comprising an insulation core that is arranged in the window area of the magnetic core,
wherein the second section of the at least one heat conducting element extends through the insulation core.

11. The cooling device of claim 10, wherein the insulation core is split into a plurality of sectors that are arranged circumferentially, and
wherein at least one sector of the plurality of sectors of the insulation core comprises the second section of a heat conducting element of the at least one heat conducting element.

12. The cooling device of claim 11, wherein each sector of the plurality of sectors of the insulation core includes one conductor bar of the plurality of preformed conductor bars.

13. The cooling device of claim 1, wherein the second section of the at least one heat conducting element extends into a center of the window area of the magnetic core.

14. The cooling device claim 1, wherein the second section of the at least one heat conducting element runs straight.

15. The cooling device of claim 1, wherein a heat conducting element of the at least one heat conducting element is a heat pipe.

16. The cooling device of claim 1, wherein a heat conducting element of the at least one heat conducting element is a copper element.

17. The cooling device of claim 1, wherein the inductor assembly is an inductor.

18. The cooling device of claim 1, wherein the inductor assembly is a choke.

19. A printed circuit board assembly comprising:
a printed circuit board having an upper side and a lower side;
an inductor assembly arranged on the upper side of the printed circuit board, the inductor assembly comprising a magnetic core and a multi-turn winding wound around the magnetic core, the magnetic core having a window area, wherein inner winding sections of the multi-turn winding are arranged in the window area;
a heat sink arranged on the lower side of the printed circuit board; and
at least one heat conducting element comprising:
a first section that is thermally coupled to the heat sink; and
a second section that extends vertically from the first section through the printed circuit board into the window area of the magnetic core.

20. The printed circuit board assembly of claim 19, wherein the at least one heat conducting element comprises a plurality of heat conducting elements, each heat conducting element of the plurality of heat conducting elements being L-shaped,
wherein each heat conducting element of the plurality of heat conducting elements comprises a first section thermally coupled to the heat sink and a second section extending into the window area of the magnetic core, and
wherein the first sections are distanced in a circumferential direction.
